(19) United States
(12) Patent Application Publication
(10) Pub. No.: US 2009/0225658 A1
(43) Pub. Date: Sep. 10, 2009

(54) MESH WITH NODES HAVING MULTIPLE ANTENNAS

(76) Inventors: Behrooz Rezvani, San Ramon, CA (US); Andrea Goldsmith, Menlo Park, CA (US)

Correspondence Address: PERKINS COIE LLP, P.O. BOX 1208, SEATTLE, WA, 98111-1208, US

(21) Appl. No.: 12/278,753

(22) PCT Filed: Nov. 19, 2007
(86) PCT No.: PCT/US07/85150

§ 371 Date: Jan. 14, 2009

Related U.S. Application Data
(60) Provisional application No. 60/859,614, filed on Nov. 17, 2006.
(60) Provisional application No. 60/931,817, filed on May 24, 2007.

(51) Int. Cl. H04L 12/26; H04L 12/28

(52) U.S. Cl. 370/241; 370/254; 370/255

(57) ABSTRACT

An architecture and protocol stack for matrix mesh wireless networks, where one or more nodes (102) and/or clients in the network have more than one antenna (208). One or more frequency bands and support devices with different communication protocols can be utilized. Matrix channel characteristics are used to establish parameters for each matrix channel in the matrix mesh network.

### CROSS-REFERENCE TO RELATED APPLICATIONS

The present application claims priority to U.S. Provisional Patent App. No. 60/859,614, filed on Nov. 17, 2006, and U.S. Provisional Patent App. No. 60/931,817, filed on May 24, 2007, both of which are incorporated by reference.

### BACKGROUND

A mesh or ad-hoc wireless network generally includes a network architecture and set of protocols to route data between wireless nodes in the network, often using intermediate nodes as relays in multi-hop routing. Mesh networking typically adjusts the routes between nodes to get around broken, blocked, or poorly performing links along the path between the source and destination node. In particular, mesh networks can be self-healing: the network can still operate even when a node breaks down or a connection goes bad by using protocols that adapt to changes in the network conditions. As a result, a reliable network can be formed. Many different neighbor discovery and routing algorithms have been used in mesh networks. These algorithms generally do not take into account multiple antennas at each node with multiple frequency bands that a given node may have access to.

State-of-the-art information (as of 2005) regarding wireless communications, including neighbor discovery and routing protocols, can be found in the book Wireless Communications, Cambridge University Press (2005), by Andrea Goldsmith.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A matrix mesh network includes matrix mesh elements, where at least one of the matrix mesh elements has multiple antennas. The channel between a matrix mesh element with multiple antennas and another wireless station may in some cases be referred to as a matrix channel. A method for neighbor discovery may include providing knowledge of one or more matrix channels in a matrix mesh network, recording matrix-channel characteristics of the matrix channels, and establishing parameters of a communication link using the matrix-channel characteristics.

A method for routing may include providing characteristics of matrix channels in a matrix mesh network, estimating end-to-end performance associated with source-destination pairs in the matrix mesh network, setting matrix communication protocols for each matrix channel in the matrix mesh network using the estimated end-to-end performance, and sending data from a source to a destination along the end-to-end routes for each source-destination pair using the matrix communication protocols.

The description in this paper describes this technique and examples of systems implementing this technique.

### BRIEF DESCRIPTION OF THE DRAWINGS

Examples of the claimed subject matter are illustrated in the figures.

FIG. 1 depicts an example of a matrix mesh network.

FIGS. 2A and 2B depict examples of systems having matrix channels.

FIG. 3 depicts a flowchart of an example of a method for matrix mesh neighbor discovery.

FIG. 4 depicts a flowchart of an example of a method for matrix mesh routing.

FIG. 5 depicts an example of a matrix mesh element.

FIG. 6 depicts a system with multi-hop routing.

FIG. 7 depicts a system that avoids interference and goes around RF blockers.

FIG. 8 depicts a plug-in access point.

### DETAILED DESCRIPTION

In the following description, several specific details are presented to provide a thorough understanding of examples of the claimed subject matter. One skilled in the relevant art will recognize, however, that one or more of the specific details can be eliminated or combined with other components, etc. In other instances, well-known implementations or operations are not shown or described in detail to avoid obscuring aspects of the claimed subject matter.

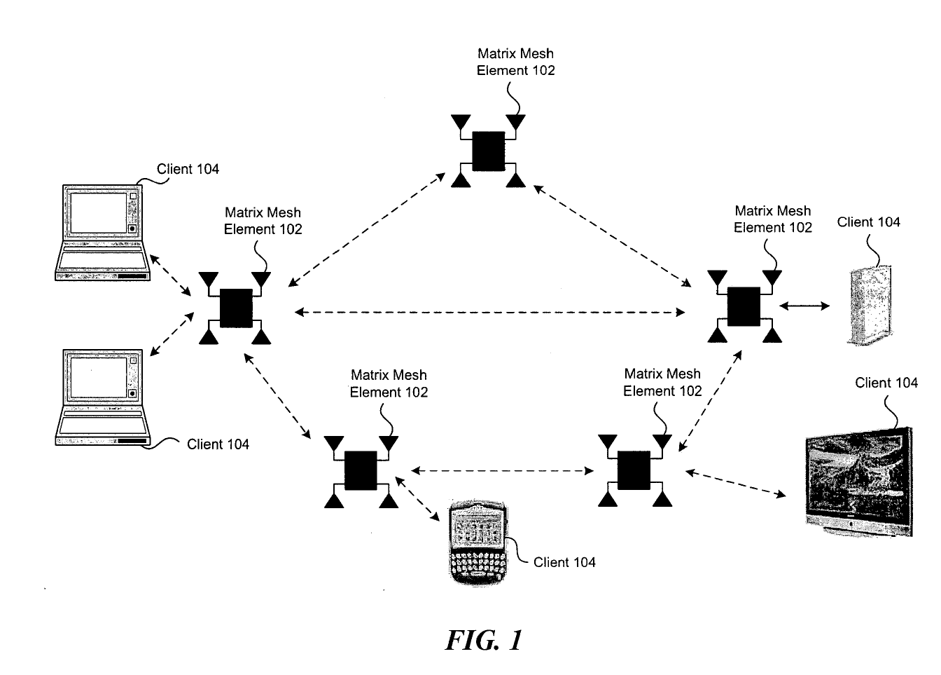

FIG. 1 depicts an example of a matrix mesh network 100. The matrix mesh network 100 includes matrix mesh elements 102 and clients 104. The matrix mesh elements 102 are wirelessly connected to one another either directly or indirectly through one or more intermediary matrix mesh elements 102. The connections depicted in FIG. 1 are arbitrary and are intended to be used for illustrative purposes only. Each of the clients 104 is coupled to the matrix mesh network 100 through one of the matrix mesh elements 102. Various types of clients 104 are depicted in the example of FIG. 1 for illustrative purposes, and are not intended to be limiting.

In an alternative, some of the clients could be wirelessly connected. In another alternative, a client could serve as a matrix mesh element. However, for illustrative purposes, a distinction is drawn between clients (as source-destination pairs of the network) and matrix mesh elements (as “relays” within the network). Accordingly, these alternatives are subsumed when appropriately characterized by location within a network, and function.

One implementation of a matrix mesh network is the VECTOR MESH™ network of Quantenna Communications, Inc. of Sunnyvale, Calif. The VECTOR MESH™ network includes VECTOR MESH™ elements or nodes, and a VECTOR MESH™ network architecture, neighbor discovery protocol, and routing protocol.

In the example of FIG. 1, the matrix mesh elements 102 are nodes within the matrix mesh network 100. A mesh is not a “matrix mesh” unless at least one node has multiple antennas. Accordingly, at least one of the matrix mesh elements 102 must have multiple antennas, or at least an antenna with multi-antenna functionality. The matrix mesh elements 102 may or may not include data of their own, but a system can take advantage of matrix mesh element network characteristics in network architecture and/or protocols. In this way, the system can adapt to traffic and/or network demands by optimizing end-to-end transmissions from a client, through at least one of the matrix mesh elements 102, to a client.

As is depicted in the example of FIG. 1, the network 100 includes interconnected matrix mesh elements 102. Advantageously, the matrix mesh network 100 can exploit the multiple antennas in an associated mesh network architecture and protocol stack. This enables routing over multiple degrees of freedom including, by way of example but not limitation, space, frequency, and time. This may enable, for example, multi-antenna routing, multi-frequency routing, time-division routing, etc. The multiple antennas can be used to make matrix channels more robust, or the antennas can be used to establish multiple spatial channels.

Advantageously, when appropriately configured, if any of the matrix mesh elements 102 support multiple communication protocols, such as Wifi, Bluetooth, or UWB, then a client using any of these protocols can connect to those elements. Although a backbone matrix mesh element will typically use the same protocol, such as Wifi, this is not required. In fact, some of the matrix mesh elements may have wide area capabilities, such as via Wimax or 3G/4G cellular technology, to provide a wider area connection from the matrix mesh network 100 to another system. Powerline communications (PLC) may also be used as a supplement to the backbone wireless mesh, to provide an additional channel, robustness, and/or security.

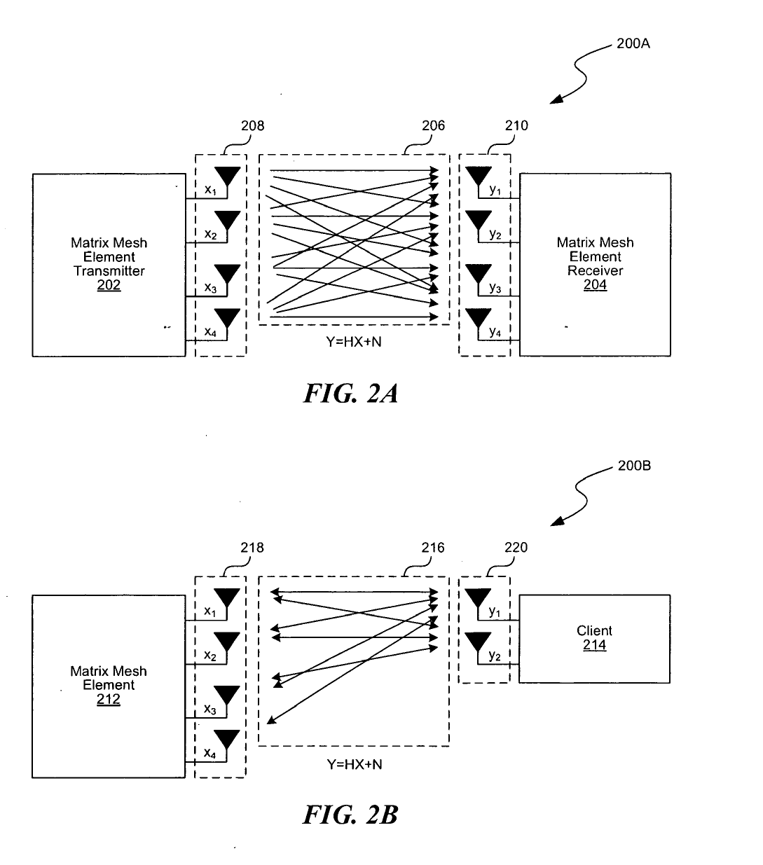

FIG. 2A depicts an example of a system 200A having a matrix channel. In the example of FIG. 2A, a matrix mesh element transmitter 202 has, for illustrative purposes only, four antennas 208 (with four inputs x₁, x₂, x₃, and x₄); and a matrix mesh element receiver 204 has, for illustrative purposes only, four antennas 210 (with four outputs y₁, y₂, y₃, and y₄). The connection between the antennas 208 and antennas 210 may be referred to collectively as a matrix channel 206. In general, any two matrix mesh elements with multiple antennas can be connected via a matrix channel. If the matrix mesh elements can communicate over more than one frequency, then they have a different matrix channel associated with each frequency.

The transmit/receive antenna gains of the matrix channel 206 are characterized by a channel gain matrix H with M_{R} rows and M_{T} columns, where M_{T} is the number of antennas at the matrix mesh element transmitter 202, and M_{R} is the number of antennas at the matrix mesh element receiver 204. The matrix H describes the channel gains between all transmit-receive antenna pairs of the two matrix mesh elements, i.e. the matrix element hᵢⱼ in the i^{th} row and j^{th} column of H is the channel gain between the j^{th} transmit antenna and the i^{th} receive antenna. The matrix H may be time-varying due to movement of the transmitter, the receiver, or objects in the environment. The transmitted signal is a vector X=[x₁, . . . x_{M}_{_{T}}], where xⱼ is the signal transmitted from the j^{th} antenna of the matrix mesh element transmitter 202. The received signal is a vector Y=[y₁, . . . y_{M}_{_{R}}], where yᵢ is the received signal at the i^{th} antenna of the matrix mesh element receiver 204. The received signal at the i^{th} receive antenna is typically corrupted by noise and possibly interference, with the sum of noise and interference given by nᵢ. Thus, noise, interference, and channel gains may all be considered characteristics of the matrix channel. The interference may be time-varying, for example it may experience multipath fading along the path from its transmitter to the receiver with which it interferes, it may be of finite duration due to a finite amount of data being sent by the interfering node, or the interfering transmitter may switch to a noninterfering frequency or direction based on improving its connection to its desired destination. The time-varying vector N=[n₁, . . . , n_{M}_{_{R}}] describes the noise and interference associated with all receive antennas. The received signal vector Y is characterized by the matrix multiplication Y=HX+N, i.e.

$${y}_{i} = {\sum }_{j = 1}^{N} {h}_{ij} {x}_{j} + {n}_{i} ,$$

so that yᵢ is the sum of signals associated with all transmit signals xⱼ, i=1, . . . , M_{T} multiplied by the channel gain hᵢⱼ from the j^{th} transmit antenna to the i^{th} receiver antenna, plus the additive noise nᵢ associated with the i^{th} receiver antenna.

A similar model applies to the bi-directional channel between a matrix mesh element and a client with one or more antennas, as shown in FIG. 2B. In the example of FIG. 2B, a system 200B includes a matrix mesh element 212, a client 214, and a matrix channel 216. This figure is easily understood in light of the description of FIG. 2A, above.

Referring once again to the example of FIG. 1, the multiple antennas between matrix mesh elements 102 can be used to increase data rates by creating multiple independent channels between the matrix mesh elements (e.g., via spatial multiplexing): the maximum number of such data paths that can be created is the minimum of M_{T} and M_{R}. Alternatively, transmitted signals can be combined via transmit diversity or beamforming, and/or the received signals can be combined via receive diversity, which increases link robustness. Also, beamsteering can be done to steer an antenna beam in a given direction, which increases range and/or reduces interference. These techniques are not mutually exclusive, and some antennas can be used for spatial multiplexing, others for diversity, and still others for beamsteering or beamforming.

While the use of multiple antennas on a point-to-point link (i.e. a link between two matrix mesh elements 102) can be optimized relative to link performance, it may also be desirable to improve end-to-end performance of the matrix mesh network. A network architecture and protocol stack can exploit the flexibility of multiple antennas at one or more matrix mesh elements 102 and/or clients 104 (as well as other features, such as the ability to use multiple frequency bands in concurrent operation). This flexibility is utilized via a protocol stack that uses the channel gain, noise, and interference characteristics, as well as potentially other characteristics, of matrix channels in the network to optimize end-to-end performance in terms of throughput, robustness/reliability, and/or delay on a per client basis. These characteristics may be referred to as matrix-channel characteristics and may be represented by themselves or by way of example but not limitation, functions of these characteristics such as the signal-to-interference-plus-noise power ratio (SINR) or relative signal strength indicator (RSSI). For example, the protocol stack may ensure a minimum robustness or average delay for a given application by measuring channel gains, noise and interference on all matrix channels along the hops of an end-to-end data route, and adapting antenna use based on this information to achieve a target packet error rate on each hop. As another example, the protocol stack may determine there is excessive interference at a given receiver, and adaptively beamsteer the antennas associated with the interfering transmitter to point in a different direction. As yet another example, the protocol stack may optimize network performance based on current network traffic and channel matrix conditions by optimally assigning frequencies and antennas used for beamsteering, diversity, or spatial multiplexing on the matrix channels of each hop along all the end-to-end routes so that performance of each of these end-to-end routes is optimized.

Advantageously, the matrix mesh network architecture is self-configuring and adaptive to changes in channel characteristics, network traffic, and to nodes entering and leaving the network. There are generally two components to the network architecture, the backbone network of the matrix mesh elements 102, and access to the backbone network by the clients 104. There are several functions that the protocol stack needs to perform to enable the self-configuring network architecture and client support, including self-configuration of the backbone mesh, access to the backbone mesh network by clients, and routing of data between clients. We now describe novel protocol design for neighbor discovery and, later, routing that can be used to exploit multiple antennas in the matrix mesh elements 102 and/or clients 104.

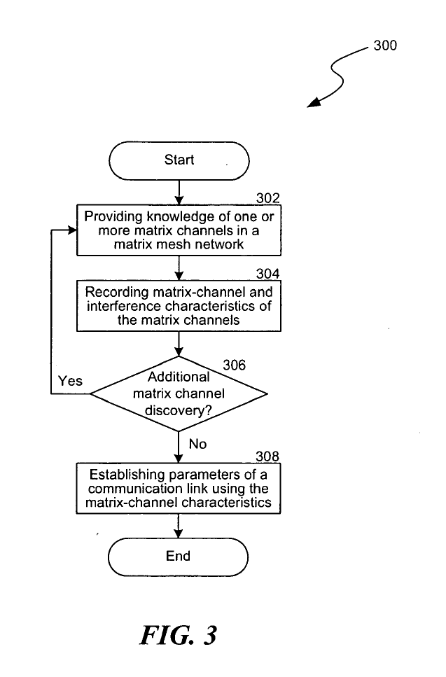

FIG. 3 depicts a flowchart 300 of an example of a method for matrix mesh neighbor discovery. Although this figure depicts functional modules in a particular order for purposes of illustration, the process is not limited to any particular order or arrangement. One skilled in the relevant art will appreciate that the various modules portrayed in this figure could be omitted, rearranged, combined and/or adapted in various ways.

For self-configuration of a matrix mesh network backbone, mesh network elements join the network through a process of neighbor discovery and, once one or more neighbors are found, establishing connections with one or more of these neighbors. Advantageously, due to the longer range and/or better robustness associated with multiple antenna channels, a neighbor discovery protocol designed for a matrix mesh element is likely to be able to establish more robust connections and to identify more neighbors than a discovery algorithm for single-antenna nodes.

In the example of FIG. 3, the flowchart 300 starts at module 302 with providing knowledge of one or more matrix channels in a matrix mesh network. The knowledge may be provided in any known or convenient fashion. For example, a node may receive a beacon with matrix channel data or from which matrix channel data can be obtained; the beacon may include a known training sequence, and the receiving node can determine channel matrix and interference statistics using signal processing applied to this known sequence. As another example, a node may probe for neighbors; the probe may include a known training sequence from which the channel between the node and its receiving neighbor is estimated, then this estimate is sent back to the probing node and used as a bi-directional channel estimate based on reciprocity, with interference measured on this return transmission. Although it may be important for actual implementations of a system, the knowledge acquisition techniques are conceptually equivalent. Thus, for illustrative purposes, only probing is described in conjunction with the modules of FIG. 3, with the understanding that one of ordinary skill in the relevant art could apply the technique to other knowledge acquisition techniques.

When probing, a node will typically choose an initial probing frequency, send a probe signal at the given frequency over all antennas, receive responses (or not) to the probe, then probe additional frequencies in the same manner. In this way, the node can probe on all antennas and frequencies in search of neighbors. The search across antennas and/or frequencies can be done sequentially or in parallel, and may be done more than once to capture the time-varying characteristics of the matrix channel. In some cases, a system will operate in only one frequency, obviating the need to choose an initial probing frequency. The weighting of a signal at each antenna may be uniform, or different weights corresponding to different diversity and/or beamforming configurations may be stepped through sequentially. After a probe signal is transmitted, the node listens for neighbor responses. The neighbors can use information about signal strength at each receive antenna to determine a robust way in terms of antenna configuration to respond to the probe.

In the example of FIG. 3, the flowchart 300 continues to module 304 with recording matrix-channel and interference characteristics of the matrix channels. For example, a neighbor may be entered into a table of neighbors along with, e.g., matrix channel gains and/or interference and/or noise characteristics between the probing node and responding node. Again referring to the probing example, if a signal strength—measured, by way of example but not limitation, using an RSSI associated with the signal—associated with a probe response at one or more antennas of the probing node is above a given threshold, then the probe response may be treated as correctly received. If more than one neighbor responds, then assuming that each response can be received correctly, the neighbors and associated data may be entered into the neighbor table.

In the example of FIG. 3, the flowchart 300 continues to decision point 306 where it is determined whether there is additional matrix channel discovery. The neighbor discovery process can be repeated periodically or aperiodically, where the time at which the process is repeated may or may not depend on how many neighbors (if any) were discovered previously, the quality of the connection to these neighbors, and how quickly the channel or network conditions are changing. It may be desirable to implement a mechanism to separate multiple neighbors that become known at approximately the same time. Any known or convenient technique for distinguishing between neighbors may be used. For example, again referring to the probing example, a random backoff (or some other technique) could be used to make each neighbor responding to a probe generally respond at different times within a response timeslot. Assuming there are additional probe frequencies, the process may also repeat at each remaining probe frequency, until all frequencies have been probed. The same frequency may be probed periodically or aperiodically, where the time at which the process is repeated may or may not depend on how many neighbors (if any) were discovered previously, the quality of the channel to these neighbors, and how quickly the channel or network conditions are changing.

If it is determined that there is additional matrix channel discovery (306-Y), then the flowchart 300 returns to module 302 and continues as described previously. For example, there may be a backoff procedure to reduce or eliminate issues pertaining to simultaneous receipt of messages from neighbors, and/or the matrix channels may be probed sequentially. If, on the other hand, it is determined that there is no additional matrix channel discovery (306-N), then the flowchart 300 continues to module 308 with establishing parameters of a communication link using the matrix-channel and interference characteristics. In this way, once all neighbors have been discovered, the matrix mesh node becomes part of the mesh network, perhaps after some control and security procedure to authenticate the node, and the flowchart 300 ends. If desired, nodes that are already part of the network could reinitiate the method, possibly depending upon the implementation, at any time or for any reason. For example, the process may be reinitiated if the communication link to a previously-determined neighbor breaks or significantly degrades, or if an application requires a more robust connection than under the current antenna configuration, so neighbor discovery is reinitiated with a different antenna configuration (e.g. reinitiating neighbor discovery with the antennas used for beamforming instead of spatial multiplexing, if this change in configuration to the current neighbor is not sufficiently robust).

Clients wishing to access a matrix mesh network may go through a similar procedure of matrix mesh element discovery as the backbone nodes, except that the clients will typically attempt to discover the matrix mesh element with which it has the best connection, and then access the network through that element. A client may become aware of a matrix mesh element when it receives a beacon frame, or “hello frame” from the element. Typically, the client then requests a connection to the element the client prefers and is then authenticated. Elements might hand off clients for end-to-end considerations, or for other reasons, and the determination may or may not be entirely internal to the network (i.e., without the consent of the client). Therefore, it may be desirable for a client to keep track of a best matrix mesh element at each frequency (assuming the client can operate on multiple frequencies), or an arbitrary number of the best matrix mesh elements, because a routing protocol may move the client off of a preferred frequency to another frequency in order to use the preferred frequency for another connection in the network.

After joining a mesh network following, e.g., neighbor discovery, a new matrix mesh element or client may activate a matrix mesh network routing algorithm to determine how to route data between different nodes in the network.

Matrix mesh routing may be capable of establishing routes based on a route cost function in either a proactive or reactive manner. Proactive routing protocols establish routes between all source-destination pairs regardless of the use or need for such routes. Thus, whenever a source has data to send to a given destination, it can use these pre-established routes, established based on cost function considerations, without any delay in route setup. Proactive routing may require significant overhead to maintain routes between all source-destination pairs even when not in use. In reactive (or dynamic) routing the route between a source and destination is not established a priori, but only when the source generates data to send to the destination, at which time the route with the best cost function is selected. Reactive routing may introduce more latency than proactive routing, since a route between the source and destination must be established before data can be sent. Typical examples of reactive routing are dynamic source routing (DSR) and ad hoc on-demand distance vector routing (AODV).

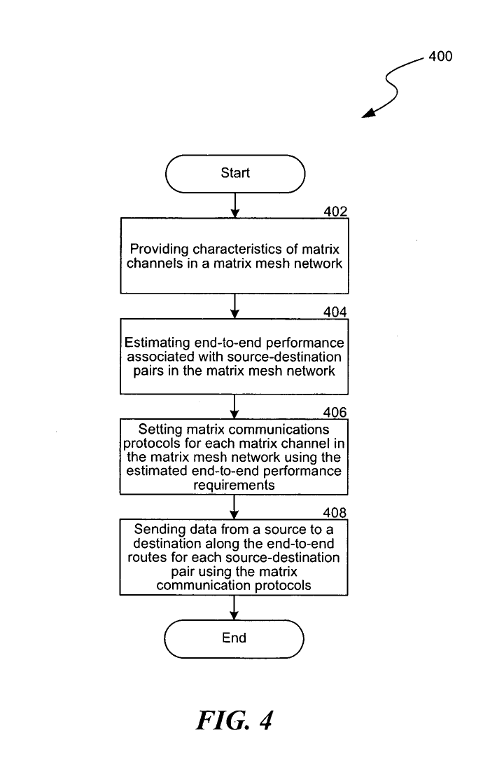

FIG. 4 depicts a flowchart 400 of an example of a method for matrix mesh routing. Although this figure depicts functional modules in a particular order for purposes of illustration, the process is not limited to any particular order or arrangement. One skilled in the relevant art will appreciate that the various modules portrayed in this figure could be omitted, rearranged, combined and/or adapted in various ways.

In general, a matrix mesh routing protocol is, for a given client source-destination pair, to find a route through the network that is optimal. Optimal may mean different things depending upon the implementation, such as by optimizing a cost function, applying a heuristic, or using some other optimization technique. Since each of these optimizing techniques are conceptually equivalent, only the cost function is described by way of example but not limitation. A route cost function may take into account multiple factors, such as by way of example but not limitation, throughput, delay, jitter, number-of-hops, etc. Each of these factors may be weighted or considered differently depending upon the desired optimization.

In the example of FIG. 4, the flowchart 400 starts at module 402 with providing characteristics associated with matrix channels in a matrix mesh network. Characteristics associated with the matrix channels may include, for example, the transmit-receive antenna gains, data regarding antennas, data regarding matrix mesh elements, frequencies, interference, noise, load, and other network characteristics. One or more of these characteristics are generally time-varying and may be measured periodically or aperiodically using known or convenient techniques. How often these characteristics are measured may depend on how quickly the network conditions change, the required robustness of the network, or the application requirements. Data acquired during neighbor discovery may be adequate for routing purposes, or additional data may be desired for implementation-specific reasons. The data may be stored centrally or in a distributed fashion, at each node or a subset of nodes. Where a cost function is used, the cost function may also be calculated at a central location or in a distributed fashion.

In the example of FIG. 4, the flowchart 400 continues to module 404 with estimating end-to-end performance associated with source-destination pairs in the matrix mesh network. When cost functions are used, the cost function may, for example, take into account weighted end-to-end performance of client source-destination pairs (assuming more than one source-destination pair). This is a fairly complex optimization problem given the large number of possible paths between source-destination pairs when both clients and all intermediate nodes have multiple antennas (which can be used to create multiple independent paths through the network) as well as multiple frequencies.

In the example of FIG. 4, the flowchart 400 continues to module 406 with setting matrix communication protocols for each matrix channel in the matrix mesh network using the estimated end-to-end performance requirements. The matrix communication protocols may include setting, by way of example but not limitation, modulation, coding, antenna use, etc. When cost functions are used, the cost functions may be ranked, and the optimal routes are those associated with the lowest total cost function for all data streams.

In the example of FIG. 4, the flowchart 400 continues to module 408 with sending data from a source to a destination along the end-to-end routes for each source-destination pair using the matrix communication protocols. When the matrix communication protocols are set, determining routes for the data streams is easy to do. Following module 408, the flowchart 400 ends. The method can be performed periodically, or for any reason. For example, it may be desirable to perform the method if there is a nontrivial change in matrix channel characteristics, such as matrix channel gains and/or interference levels, because matrix channel measurements may be used to compute cost functions associated with each path. It may also be desirable to perform the method if there is a nontrivial change in traffic characteristics such that changing the routes and associated link communication protocols associated with one or more traffic streams may result in better overall network performance.

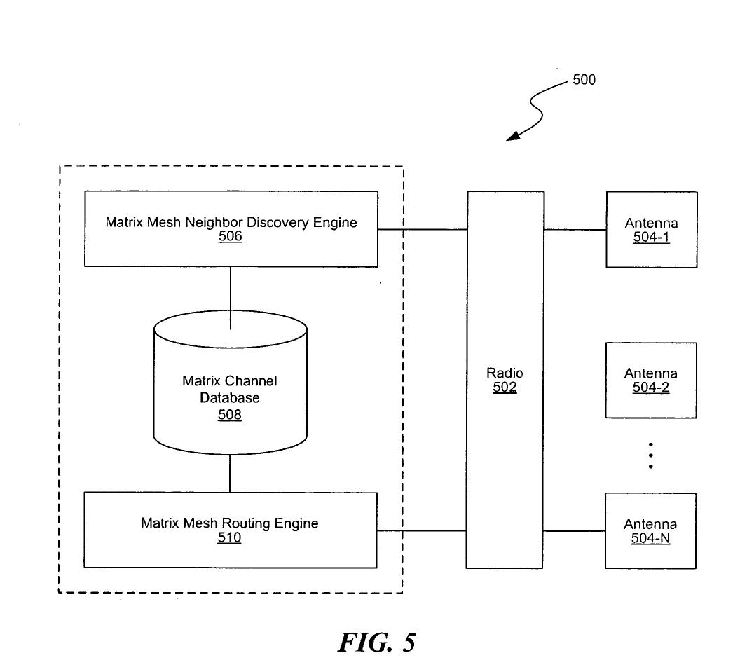

FIG. 5 depicts an example of a matrix mesh element 500. The matrix mesh element 500 includes a radio 502, antennas 504-1 to 504-N (referred to collectively as antennas 504), a matrix mesh neighbor discovery engine 506, a matrix channel database 508, and a matrix mesh routing engine 508.

The radio 502 may include receiver(s), transmitter(s), and/or transceiver(s). The radio 502, which may include multiple radios but are nevertheless referred to as the radio 502 herein, may have known or convenient capabilities and/or settings. The radios of matrix mesh elements that make up a matrix mesh network may or may not have the same or similar characteristics. The antennas 504, which are coupled to the radio 502, may also have known or convenient capabilities and/or settings.

The matrix mesh neighbor discovery engine 506, matrix channel database 508, and matrix mesh routing engine 510 may be implemented in a computer-readable medium. As used herein, an engine includes a known or convenient processor to execute hardware or software components. The processor(s) associated with the matrix mesh neighbor discovery engine 506 may or may not be the same as a processor that drives access to the matrix channel database 508 and/or is included in the matrix mesh routing engine 510. Moreover, memory and/or non-volatile storage associated with any of the components may or may not overlap.

The matrix mesh neighbor discovery engine 506 is coupled to the radio 502 and the matrix channel database 508. The matrix mesh neighbor discovery engine 506 implements a neighbor discovery process, such as the method described with reference to FIG. 3. In a typical implementation, at least some of the data collected during neighbor discovery is stored in the matrix channel database 508.

The matrix mesh routing engine 510 is coupled to the radio 502 and the matrix channel database 508. The matrix mesh routing engine 506 implements a routing process, such as the method described with reference to FIG. 4. In a typical implementation, data from the matrix channel database 508 is used to determine end-to-end routes for a client-source pair coupled to the network. Such a determination may be distributed such that the matrix mesh element 500 only knows enough to determine a next hop. Alternatively, more information may be stored. For example, the matrix mesh routing engine 510 could maintain a routing table that includes more information than a next hop alone.

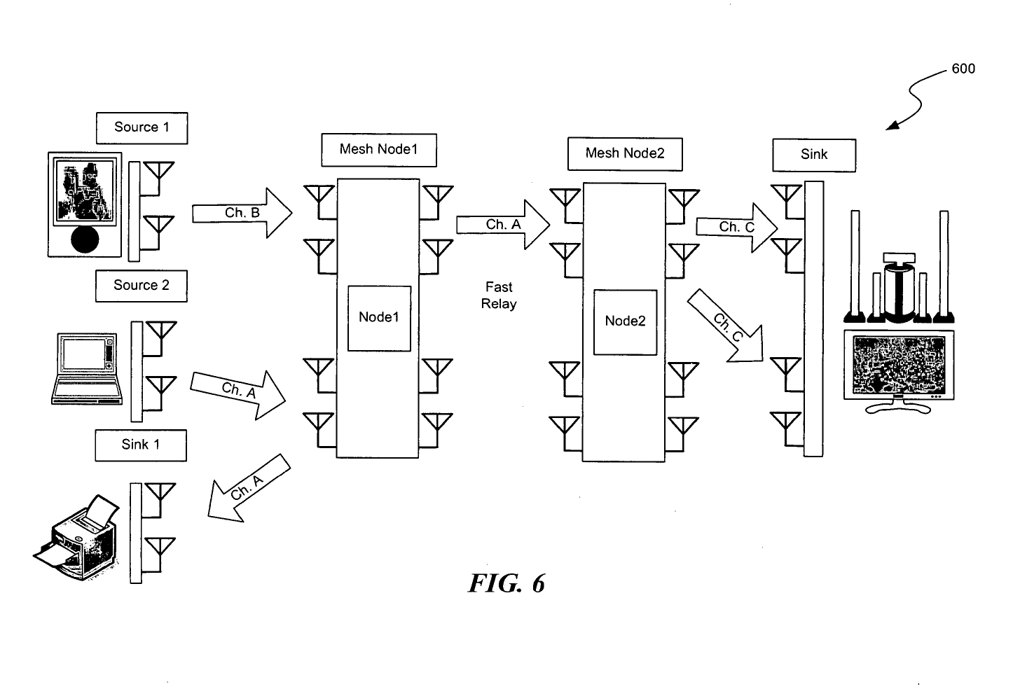

Advantageously, matrix mesh routing exploits matrix channel and interference information at each available frequency between matrix mesh elements and between clients and their corresponding matrix mesh element to determine an optimal end-to-end route through the network as a function of a given performance metric, which may be a function of raw data rate, throughput, delay, and/or jitter. A route from a client to another client in the network may utilize multi-hop routing across multiple matrix mesh elements, as well as multiple frequencies, as shown in FIG. 6 for a matrix mesh network 600 with five clients, two matrix mesh elements, and three frequency channels (A, B, and C).

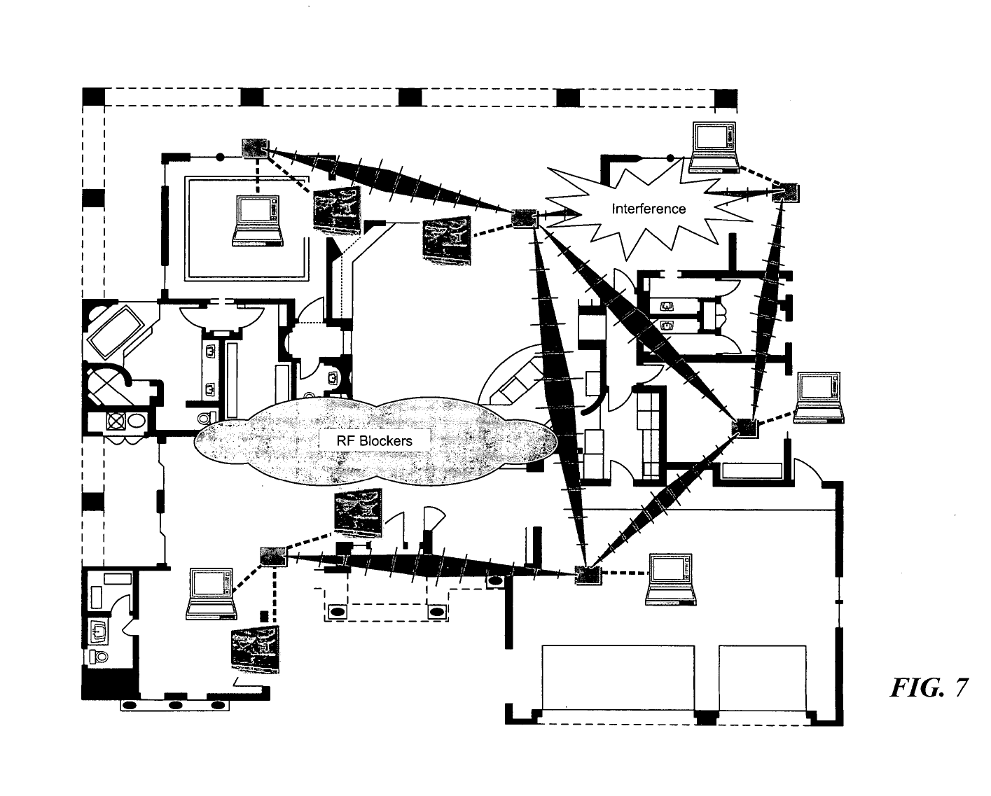

It may be desirable to avoid interference and go around RF blockers, as shown in FIG. 7. In some implementations, this functionality is inherent because a cost function will generally be very high to use a link with high interference or for which the channel gains are very low due to RF blockage. Thus, the routing algorithm will tend to avoid routes with these characteristics, unless they are the only possible routes between a source-destination pair, so that the routes must be used.

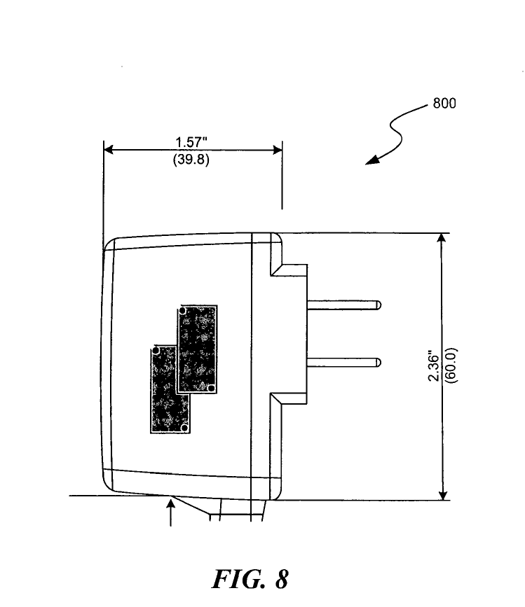

Matrix mesh elements may be deployed in a known or convenient package. Some well-known packages include battery-powered access points (APs) and those that receive power over Ethernet (PoE). A plug-in AP 800, depicted for illustrative purposes in FIG. 8, is not generally known. This is a convenient configuration since it plugs directly into the wall, and hence there is no need for a power cord.

Matrix mesh elements may also be deployed outdoors. In an outdoor setting, it may be desirable to design matrix mesh elements with high efficiency solar cells. Matrix mesh elements with solar cells may be of particular value when implemented in an outdoor matrix mesh, or in the portion of a matrix mesh that extends outdoors.

Systems described herein may be implemented on any of many possible hardware, firmware, and software systems. Typically, systems such as those described herein are implemented in hardware on a silicon chip. Algorithms described herein are implemented in hardware, such as by way of example but not limitation RTL code. However, other implementations may be possible. The specific implementation is not critical to an understanding of the techniques described herein and the claimed subject matter.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A method comprising:
providing knowledge of one or more matrix channels in a matrix mesh network;
recording matrix-channel characteristics of the matrix channels;
establishing parameters of a communication link using the matrix-channel characteristics.

2. The method of claim 1 further comprising self-configuring when stations enter or leave the matrix mesh network.

3. The method of claim 1 further comprising adapting to changes in channel characteristics selected from the group consisting of gain, interference, and noise.

4. A method comprising:
providing characteristics of matrix channels in a matrix mesh network;
estimating end-to-end performance associated with source-destination pairs in the matrix mesh network;
setting matrix communication protocols for each matrix channel in the matrix mesh network using the estimated end-to-end performance;
sending data from a source to a destination along the end-to-end routes for each source-destination pair using the matrix communication protocols.

5. The method of claim 4 further comprising combining signals via transmit diversity.

6. The method of claim 4 further comprising combining signals via receive diversity.

7. The method of claim 4 further comprising using each of multiple antennas at a matrix node for different spatial channels.

8. The method of claim 4 further comprising routing over multiple degrees of freedom.

9. The method of claim 4 further comprising selecting one of multiple frequencies and an associated matrix channel of the matrix channels.

10. The method of claim 4 further comprising prioritizing data, wherein setting the matrix communication protocols includes using the prioritization.

11. The method of claim 4 further comprising calculating a cost function for use in setting the matrix communication protocols.

12. The method of claim 4 further comprising using a heuristic to set matrix communication protocols.

13. The method of claim 4 further comprising beamsteering with multiple antennas.

14. The method of claim 4 further comprising probing for neighbors.

15. The method of claim 4 further comprising sequentially probing on all antennas and operating frequencies in search of neighbors.

16. The method of claim 4 further comprising probing in parallel on all antennas and operating frequencies in search of neighbors.

17. The method of claim 4 further comprising receiving beacon frames from neighbors.

18. A system comprising:
a matrix mesh element including:
a plurality of antennas;
a radio coupled to the plurality of antennas;
a matrix mesh neighbor discovery engine, coupled to the radio, embodied in a computer-readable medium;
a matrix channel database, coupled to the matrix mesh neighbor discovery engine,
wherein, in operation, the matrix mesh neighbor discovery engine uses the radio to acquire knowledge of a one or more matrix channels, associated with the plurality of antennas, between the matrix mesh element and a station and stores the matrix-channel characteristics of the one or more matrix channels in the matrix channel database.

19. The system of claim 18 further comprising a matrix mesh routing engine embodied in a computer-readable medium, wherein, in operation, the matrix mesh routing engine sets matrix communication protocols for the one or more matrix channels.

20. The system of claim 18, wherein the matrix mesh element is a first matrix mesh element, further comprising the station, wherein the station is a second matrix mesh element.

21. The system of claim 18, further comprising the station, wherein the station is a wireless client.

22. The system of claim 18, further comprising a backbone network of matrix mesh elements, including the matrix mesh element.

23. The system of claim 18, further comprising a solar cell coupled to the matrix mesh element, wherein, in operation, the matrix mesh element receives power from the solar cell.

24. The system of claim 18, further comprising a plug configured to fit into a power outlet, wherein, in operation, the matrix mesh element receives power from a power source through the plug.

25. The system of claim 18, wherein the matrix mesh element is configured for use in an outdoor matrix mesh.
